(19) United States
(12) Patent Application Publication
(10) Pub. No.: US 2006/0200612 A1
(43) Pub. Date: Sep. 7, 2006

(54) Method and protocol for transmitting extended commands to USB devices

(76) Inventors: Laurence Hamid, Ottawa (CA); Marc Charbonneau, Casselman (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/068,791

(22) Filed: Mar. 2, 2005

(51) Int. Cl. G06F 13/20

(52) U.S. Cl. 710/313

(57) ABSTRACT

A method is disclosed for transferring data via a USB interface. A workstation is provided having an interface therein supporting a first set of known commands. A USB device is provided for interfacing with the interface and supporting a second set of known commands, the second set including some commands absent from the first set of commands. A first command is provided from the second set of commands and absent from the first set of commands for execution on the USB device. The first command is provided on the workstation. The first command is encapsulated within data associated with a second other command, the second other command within the first set of commands. The first command is encapsulated within the data for extraction thereof. The second other command and the data associated with a second other command are transmitted to the USB device via the interface. Once received, the first command is extracted from the second other command and the first command is executed on the USB device.

### FIELD OF THE INVENTION

The invention relates to the field of universal serial bus (USB) devices and protocols for communicating commands with said devices.

### BACKGROUND OF THE INVENTION

In recent years, there has been growing use of the universal serial bus (USB). USB ports are adaptable to being used with many different devices. USB devices include printers, scanners, keyboards, cameras, computer mice, joysticks, non-volatile storage, optical drives, etc. USB ports are efficient as they allow a fast data transfer rate, in the range of 8 MB/second read and 6 MB/second write.

Also, several different flash drive memory sticks have been developed that are effectively USB portable storage devices which are compact and hold a large capacity of information in the range of 128 MB-4 GB. These devices receive power from the USB port and do not require a further power source or cable. Typically these memory sticks are “Plug and Play” devices, using existing “standard” device drivers such that they operate identically on all systems without any device driver installation. Using Microsoft® Windows XP®, when a computer detects that a USB device has been plugged in, the PC automatically interrogates the device to learn its capabilities and requirements. Using this information, the PC then automatically loads a driver for supporting the determined capabilities and requirements into the operating system. These drivers support existing functions and prevent operations that are either unsupported or potentially problematic. Later, when the device is unplugged from the bus, the operating system automatically logs off the device from the bus and unloads its driver from the system.

USB devices are sold with internally stored software, referred to as firmware, for execution within the device and for control thereof. This firmware is typically stored in a non-volatile, electrically erasable, programmable memory and is executed by a microcontroller within the device.

However, since the standard generic device drivers for USB devices limit the functionality of the devices by supporting certain specified commands and filtering of non-existent and illegal commands, there exists a need to install device drivers for devices having non-standard command sets or supporting additional functionality. It would be advantageous to provide a method and apparatus for communicating with a USB device or the like, using a standard device driver but supporting additional functionality.

### SUMMARY OF THE INVENTION

In accordance with the invention there is provided a method of transferring data via an interface comprising: providing a first device having an interface therein supporting a first set of known commands; providing a second device for interfacing with the interface and supporting a second set of known commands, the second set including some commands absent from the first set of commands; providing a command from the second set of commands and absent from the first set of commands for execution on the second device, the command provided on the first device; encoding the first command within data associated with a second other command, the second other command within the first set of commands, the first command encoded within the data for extraction thereof; transmitting the second other command and the data associated with a second other command to the second device via the interface; and extracting the first command from the second command and executing of the first command on the second device.

In accordance with another embodiment of the invention there is provided a method comprising: providing a first command for execution and for resulting in a data result therefrom; encoding the first command within data associated with a second other command; transmitting the second other command and the associated data for execution thereof; extracting the first command from the second other command and executing of the first command to produce first response data; transmitting a third command for execution thereof, the third command for retrieving of data; and, in response to the third command providing the first response data.

In accordance with another aspect of the invention there is provided a device comprising: an interface therein supporting a first set of known commands; and an application for, in execution, providing a command from a second set of commands and absent from the first set of commands for execution on another device and for encoding the first command within data associated with a second other command, the second other command within the first set of commands, the first command encoded within the data for extraction thereof and for providing the second other command and the data associated with a second other command to the interface.

In accordance with another embodiment of the invention there is provided a device comprising: an interface; and a microcontroller and firmware for receiving a command, for extracting from the command a first command, and for executing of the first command.

In accordance with another embodiment of the invention there is provided a device comprising: an interface; and an application for, in execution, providing a first command for execution and for resulting in a data result therefrom, encoding the first command within data associated with a second other command, providing the second other command and the associated data to the interface, providing a third command for retrieving of data to the interface, and receiving data in response to the first command in response to the third command.

In accordance with another embodiment of the invention there is provided a device comprising: an interface; and a microcontroller and firmware for receiving an encapsulated command, the encapsulated command encoded within data associated with a second other command, receiving a third command for retrieving of data from the device, extracting the encapsulated command, executing the extracted encapsulated command to generate first response data, and in response to the third command providing the first response data.

In accordance with another aspect of the invention there is provided a storage medium having data stored therein for when executed: providing a command from a second set of commands and absent from the first set of commands supported by an interface for execution on another device and for encoding the first command within data associated with a second other command, the second other command within the first set of commands, the first command encoded within the data for extraction thereof and for providing the second other command and the data associated with a second other command to the interface.

In accordance with another embodiment of the invention there is provided a storage medium having data stored therein for when executed: providing a first command for execution and for resulting in a data result therefrom, encoding the first command within data associated with a second other command, providing the second other command and the associated data to an interface, providing a third command for retrieving of data to the interface, and receiving data in response to the first command in response to the third command.

In accordance with another embodiment of the invention there is provided a storage medium having data stored therein for when executed: providing a first command for execution and for resulting in a data result therefrom, encoding the first command within data associated with a second other command, providing the second other command and the associated data to an interface, providing a third command for retrieving of data to the interface, and receiving data in response to the first command in response to the third command.

In accordance with another embodiment of the invention there is provided a storage medium having data stored therein for when executed: receiving an encapsulated command, the encapsulated command encoded within data associated with a second other command, receiving a third command for retrieving of data from the device, extracting the encapsulated command, executing the extracted encapsulated command to generate first response data, and in response to the third command providing the first response data.

In accordance with the invention there is provided a peripheral device comprising data stored therein, the data for when executed by a processor of a computer in communication with the peripheral device for supporting communication with the peripheral device and for supporting peripheral device specific operations.

Preferably, the peripheral device is a USB memory device.

In accordance with the invention there is provided a method comprising executing application data, the application data stored within a peripheral device, the application for, when executed, supporting communication with the peripheral device; performing at least an operation unavailable to the processor absent execution of the application data and relating to communication between the processor and the peripheral device.

### BRIEF DESCRIPTION OF THE DRAWINGS

Exemplary embodiments of the invention will now be described in conjunction with the following drawings, in which:

FIG. 1 illustrates the interconnectivity between a personal computer and a flash drive memory stick according to the first embodiment of the invention;

FIG. 2a illustrates the communication flow between a host computer and a peripheral USB device according to a first embodiment of the present invention;

FIG. 2b illustrates the contents of the command block wrapper during the process of transmitting an extended command according to the present invention;

FIG. 2c illustrates the contents of the data packet during the process of transmitting an extended command according to the present invention;

FIG. 3a illustrates the communication flow between a host computer and a peripheral USB device according to a first embodiment of the present invention;

FIG. 3b illustrates the contents of the command block wrapper during a response to the process of transmitting an extended command according to the present invention; and,

FIG. 3c illustrates the contents of the data packet during a response to the process of transmitting an extended command according to the present invention.

### DETAILED DESCRIPTION OF EMBODIMENTS OF THE INVENTION

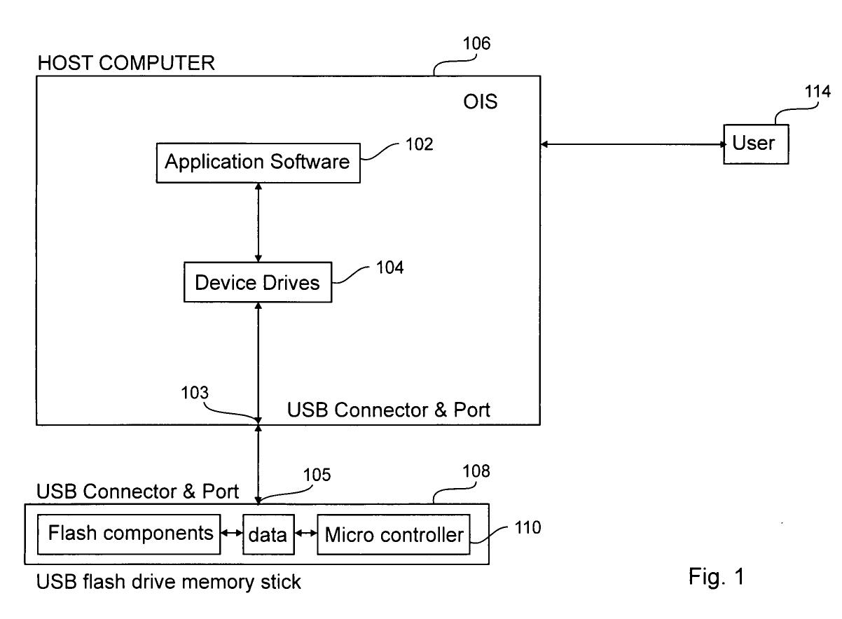

FIG. 1a is a block diagram illustrating interconnectivity between a personal computer 106 and a flash drive memory stick 108 for carrying out an embodiment of a method of the invention. In this figure, there is illustrated a workstation 106, with a USB port 103. The flash drive memory stick 108 is coupled through the USB electrical interface 105 and the USB port 103 to the workstation 106 and is for storing information therein. The USB electrical interface 105 typically comprises a cable and a connector, which is a physical interface for receiving and transmitting electrical signals, which are compatible with the USB specification. A device driver 104 in execution on the workstation 106 acts as a communication bridge between application software 102 and a device coupled to the USB port. Thus a user 114 of the workstation 106 is able to transmit data to and receive data from the flash drive memory stick 108. The application software 102 in execution on the workstation 106 transmits and receives data from the flash drive memory stick 108 in accordance with a standard command set. For other than standard supported commands, the application encapsulates commands within a data packet forming part of a standard write command to the USB flash drive memory stick 108. The write command including the encapsulated data is provided to the device driver for being provided to the USB flash drive memory stick 108. The device driver 104 passes this command to the USB flash drive memory stick as it appears to be an acceptable write command. Thus, additional commands are communicated to the USB flash drive memory stick 108 absent installation of a device driver specific to the USB hardware.

By encapsulating the new command used to control and manipulate the data of the flash drive memory stick 108 within a data packet, the application software 102 located on the host computer 106 effectively masks the new command such that it will be compatible with a standard USB device driver specification for a flash drive memory stick 108. Alternatively, the encapsulated data is stored within another data transfer command.

The flash drive memory stick 108 shown in FIG. 1 comprises a microcontroller 110 located therein for supporting the functionality and control of the flash drive memory stick 108. This microcontroller is used for extracting and processing of commands and encapsulated data packets, when present, received from the host computer 106. When the host computer 106 transmits commands to the microcontroller 110 through the device driver 104, the microcontroller processes these commands, performs functions based on the commands, and acknowledges performance of the commands in accordance with the standard.

According to the present invention, the implementation of the additional commands unsupported in the standard USB device driver is possible. Further, by upgrading the firmware within a device, new commands can be added after the device has already been shipped to end customers allowing for extended functionality, repair of security errors or breaches, support of different software as it is developed, etc. For example, to support an automatic formatting command, the firmware must recognize and support an automatic formatting function. Then, to execute the function, the formatting command is encapsulated within a data packet and transmitted by the application software 102 to the device driver 104 within a write command. The device driver then transmits the command packet within the write command to the flash drive memory stick 108 where it is extracted by the microcontroller 110. The microcontroller then executes the command within the USB flash drive memory stick 108. Optionally, the flash drive memory stick 108 transmits status data to notify the host computer 106 of a result of an operation.

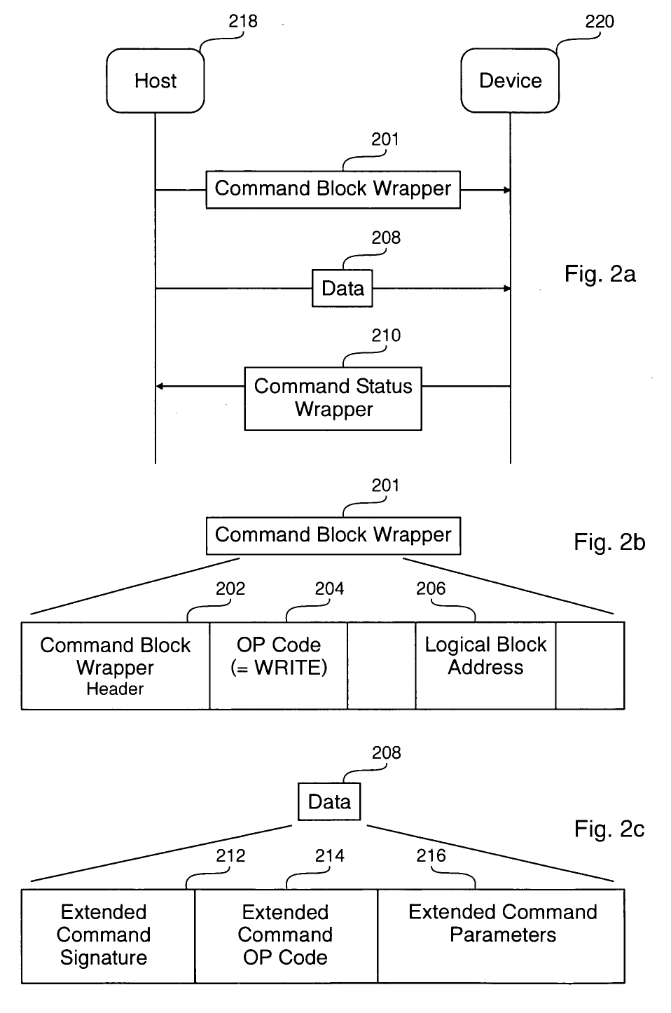

FIG. 2a shows a communication between a workstation 218 and a peripheral USB device 220 for transmitting an extended command. The workstation 218transmits a command block wrapper 201 to the USB device 220. The command block wrapper 201 is shown in FIG. 2b and comprises a command block wrapper header 202, an operation code 204 in the form of a write command operation code supported in a standard device driver for the USB peripheral device, and a logical block address 206. Following the command block wrapper 201 data 208 is provided in the form of encapsulated data encapsulated within data for provision to the peripheral USB device 220 following the command block wrapper 201. For example, the encapsulated data is encapsulated within the command as data for being stored at the logical block address in response to execution of, for example, a write command. The command block wrapper optionally comprises a CRC value. This command block wrapper 201 meets the existing USB standards.

The application software encapsulates the extended command signature 212, within the data packet 208. This extended command signature 212 is generated as a sequence of bits approximately distinct in their pattern sequence. Optionally, this sequence is determined through a handshake with the peripheral USB device to ensure uniqueness and synchronization. Further optionally, this sequence of bits is generated using a random number generator, the random number generated is synchronized with the USB device 220 random number generator.

The command block wrapper 201 is provided to the device driver for provision to the peripheral USB device 220 and is provided thereto. The data is then provided to the device driver for provision to the peripheral USB device 220 and is provided thereto. As shown in FIG. 2c, the encapsulated data comprises an extended command signature 212, an extended command operation code 214, and extended command parameters 216; the encapsulated command has content and form known to the microcontroller code that supports extended commands on the device. When a CRC is present, the checksum is for ensuring that the packet has been received without corruption. The length of the number generated is relatively long such that the sequence of bits is unlikely to occur within the data packet for an actual write command.

Upon receiving the original write command in the command block wrapper 201, the microcontroller 110, expects to receive data 208 subsequent including the data to be stored within the memory of the flash drive memory stick 108. For an extended command, the data packet 208, which follows the write command in the command block wrapper 201, now contains an extended command signature 212. Upon detecting the sequence of bits defining the extended command signature 212 within the encapsulated data, the microcontroller 110 recognizes the packet as containing an extended command. The microcontroller 110 then reads the sequence of bits following the extended command signature 212. The extended command operation code 214 defines the extended command to be performed. The microcontroller 110 then executes an operation based on the extended command in accordance with the extended command parameters 216.

Optionally, the microcontroller comprises a packet extractor, which extracts the extended command operational code 214 from the encapsulated data 208 and then places the extended command and its parameters back into the receive queue to the application command interpreter of the microcontroller.

When the microcontroller 110 of the flash drive memory stick 108 completes execution of the extended operation, it transmits to the host computer through the device driver 104 that the status of the flash drive memory stick 108 has changed. For example, an ACK signal is provided to indicate that the command has been executed successfully. This “write status packet” is depicted in FIG. 2a as a command status wrapper 210. The device driver 104 reads the command status wrapper 210 comprising a status field (not shown) containing information on the status of the command.

Unfortunately, though a plurality of extended commands are supported with command encapsulation, there is no mechanism to transfer other than a rudimentary ACK signal from the peripheral USB device 220 to the workstation. Set out below is a method for supporting retrieval of data from the peripheral USB device 220 and using extended commands for generating the retrieved data.

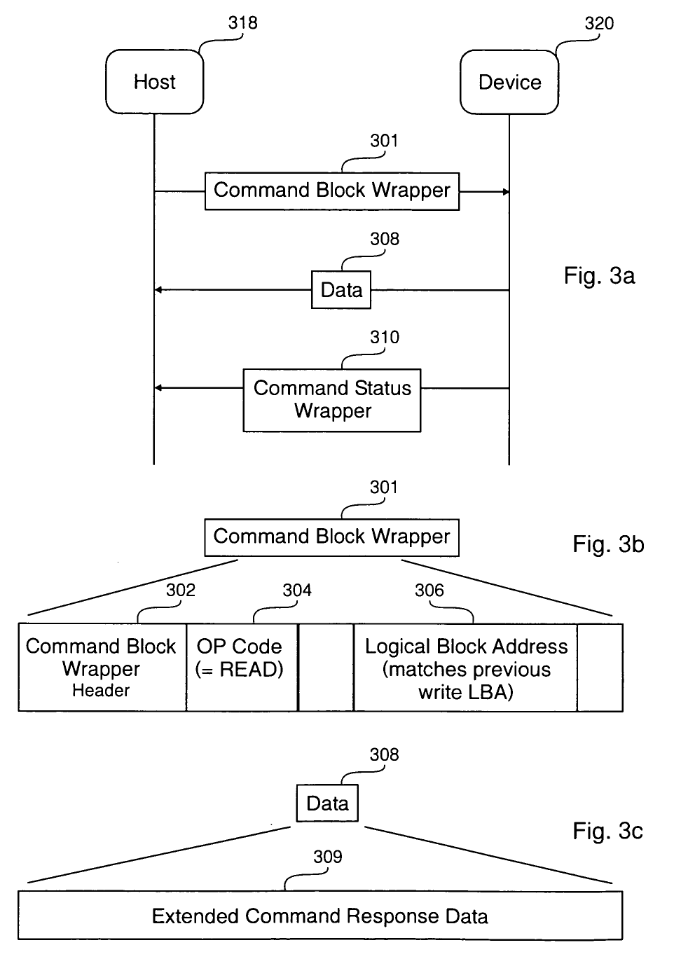

FIG. 3a shows the communication flow between the host computer and the peripheral USB device such as the flash drive memory stick. This figure illustrates packet transactions to support an extended read operation—an operation wherein a response other than a standard response is expected from the peripheral USB device 220.

The response transaction begins with a “read command” transmitted from the host computer 318 to the USB device 320 in the form of a command block wrapper 301. The command block wrapper 301 as further illustrated in FIG. 3b comprises a command block wrapper header 302, the operation code 304 in the form of an operation code for a read command, and a logical block address 306. The logical block address 306 described herein is equivalent to the logical block address 206 for a write command described previously. Upon receiving the command block wrapper packet 301 with the logical block address 306, the microcontroller within the USB device is able to transmit a response to a previous extended command using a proceeding data packet 308. The microcontroller is expecting such a command since it has data awaiting transmission to the workstation 318 gathered in response to a previous extended command. The application also expects the response since it provided the initial extended command upon which generated the data. The command block wrapper optionally comprises a CRC value. This command block wrapper 301 satisfies the existing USB standards and as such is compatible with generic USB device drivers. The use of a read command obviates a need for special formatting of data thereby retrieved.

The transmit of the command block wrapper 301 by the workstation 318 is followed by a response from the USB device 320 in the form of a response data packet 308. This response is required by the host computer 318 in order to obtain the result of the extended command, which it has sent earlier in data packet 208.

As shown in FIG. 3c, the data packet 308 comprises an extended command response data 309. The data packet 308 optionally comprises a CRC value, which contains a checksum, for determining that the data has been received without corruption. Once received by the workstation 318, the application software 102 then processes the response. Though the data is described as extended command response data, it is normal data in response to an extended command. Alternatively, the extended command response data is processed for security or data transmit efficiency.

When the microcontroller 110 of the flash drive memory stick 108 completes an extended operation, it signals to the host computer through the device driver 104 that the status of the flash drive memory stick 108 has changed, by sending a read status packet in the form of an ACK signal. This status packet is depicted in FIG. 3a as a command status wrapper 310. The device driver 104 then reads the command status wrapper 310 comprising a status field (not shown), which contains information on the completion status of the write command. Of course, this command status wrapper is in accordance with USB standard device driver expected outcomes to maintain compatibility with existing USB device drivers. Additional command status wrapper data is optionally included within the data when advantageous.

As per another embodiment of the invention, the method and protocols described in the first embodiment of the invention are implemented for USB devices other than flash drive memory sticks including but not limited to printers, scanners, cameras, video cameras or the like. In a similar reasoning as that above, this enables a user to request extended commands such as editing, formatting, device configuration, device option setting, and other data or device manipulations, by encapsulating the commands within a data packet following a command block wrapper for transmitting a write command. For example, this protocol enables a user to request extended commands through application software but since the extended commands are encapsulated within a data packet, it is compatible with generic device drivers located on a workstation in the form of a host computer. The commands are then implemented by the microcontroller located on the USB device without a need to update the device's driver.

In accordance with an embodiment, the application for execution on the workstation 218 is stored within memory of the peripheral USB device. As such, the peripheral USB device is self-contained, operates with standard device drivers and is fully controllable through the use of the application stored therein. For use with peripheral USB devices such as video cameras, digital cameras, and memory sticks supporting extended functions such as user authentication, storing the application within memory of the peripheral device allows for the device to be used on any of a large number of computer systems absent installation of a device specific device driver thereon. This is very convenient and therefore highly advantageous.

Optionally, the application stored within the peripheral USB device only supports some extended functions and a separate application is necessary to support other extended functions. For example, initial setup commands are stored on a workstation of the owner of a device to store owner information for use in tracking the device for legal purposes. The application(s) within the device are for configuring the device but cannot change that data. The original application is then required to change that data. This feature is very useful in enterprise applications wherein it is desirable to have some functions only performed by, for example, the IT department and yet it is desirable to support other extended functions for use by everyone with the device.

Numerous other embodiments may be envisaged without departing from the spirit or scope of the invention.

What is claimed is:

1. A method of transferring data via an interface comprising:
providing a first device having an interface therein supporting a first set of known commands;
providing a second device for interfacing with the interface and supporting a second set of known commands, the second set including some commands absent from the first set of commands;
providing a first command from the second set of commands and absent from the first set of commands for execution on the second device, the first command provided on the first device;
encapsulating the first command within data associated with a second other command, the second other command within the first set of commands, the first command encapsulated within the data for extraction thereof;
transmitting the second other command and the data associated with the second other command to the second device via the interface; and
extracting the first command from the second other command and executing of the first command on the second device.

2. A method according to claim 1 wherein the interface is a USB interface.

3. A method according to claim 1 wherein the second device includes a microcontroller for execution of the first command.

4. A method according to claim 3 wherein the first command is a command for determining a response and wherein the response is stored by the microcontroller in anticipation of a subsequent data retrieval command, the response provided in response to the subsequent data retrieval command.

5. A method according to claim 3 wherein the first command is a command for determining a response and wherein the command is unexecuted by the microcontroller until receipt of a subsequent data retrieval command, the response determined and provided in response to the subsequent data retrieval command.

6. A method according to claim 5 wherein the response includes security data.

7. A method according to claim 5 wherein the response is data retrieved from memory within the device.

8. A method according to claim 7 wherein the response includes security data.

9. A method according to claim 5 wherein the response is determined through processing performed by the microcontroller.

10. A method according to claim 2 wherein the first set of commands is a set of commands supported by a standard device driver for the class of devices.

11. A method according to claim 10 wherein the class of devices includes removable storage devices.

12. A method according to claim 1 wherein an address field of the first command is same as an address field of the third command.

13. A method according to claim 1 wherein the first command encapsulated within the data includes a signature for identifying of the first command within the second other command.

14. A method comprising:
providing a first command for execution and for resulting in a data result therefrom;
encoding the first command within data associated with a second other command;
transmitting the second other command and the associated data for execution thereof;
extracting the first command from the second other command and executing of the first command to produce first response data;
transmitting a third command for execution thereof, the third command for retrieving of data; and,
in response to the third command providing the first response data.

15. A method according to claim 14 wherein
providing and encoding are performed on a first device,
wherein extracting and in response to the third command providing are performed on a second other device, and
wherein transmitting is performed between the first device and the second other device.

16. A method according to claim 15 wherein the first device and the second other device are coupled by a USB port.

17. A method according to claim 16 wherein the first device is a workstation and the second device is a peripheral USB device.

18. A method according to claim 17 wherein the peripheral USB device is a USB removable storage device.

19. A method according to claim 14 wherein an address field of the first command is same as an address field of the third command.

20. A method according to claim 14 wherein the encapsulated command includes a signature for identifying of the encapsulating command within the second other command.

21. A device comprising:
an interface therein supporting a first set of known commands; and
an application for, in execution, providing a command from a second set of commands and absent from the first set of commands for execution on another device and for encoding the first command within data associated with a second other command, the second other command within the first set of commands, the first command encoded within the data for extraction thereof and for providing the second other command and the data associated with a second other command to the interface.

22. A device according to claim 21 wherein the interface comprises a USB port and a device driver for transmitting and receiving of data via the USB port.

23. A device comprising:
an interface; and
a microcontroller and firmware for receiving a command, for extracting from the command a first command, and for executing of the first command.

24. A device according to claim 23 wherein the interface includes a USB interface port.

25. A device comprising:
an interface; and
an application for, in execution, providing a first command for execution and for resulting in a data result therefrom, encoding the first command within data associated with a second other command, providing the second other command and the associated data to the interface, providing a third command for retrieving of data to the interface, and receiving data in response to the first command in response to the third command.

26. A device according to claim 25 wherein the interface comprises a USB port and a device driver for transmitting and receiving of data via the USB port.

27. A device comprising:
an interface; and
a microcontroller and firmware for receiving an encapsulated command, the encapsulated command encoded within data associated with a second other command, receiving a third command for retrieving of data from the device, extracting the encapsulated command, executing the extracted encapsulated command to generate first response data, and in response to the third command providing the first response data.

28. A device according to claim 27 wherein the interface includes a USB interface port.

29. A storage medium having data stored therein for when executed:
providing a command from a second set of commands and absent from the first set of commands supported by an interface for execution on another device and for encoding the first command within data associated with a second other command, the second other command within the first set of commands, the first command encoded within the data for extraction thereof and for providing the second other command and the data associated with a second other command to the interface.

30. A storage medium having data stored therein for when executed:
for receiving a command, for extracting from the command a first command, and for executing of the first command.

31. A storage medium according to claim 30 wherein the storage medium comprises a USB storage device.

32. A storage medium according to claim 31 wherein the USB storage device comprises a USB flash memory storage device.

33. A storage medium having data stored therein for when executed:
providing a first command for execution and for resulting in a data result therefrom, encoding the first command within data associated with a second other command, providing the second other command and the associated data to an interface, providing a third command for retrieving of data to the interface, and receiving data in response to the first command in response to the third command.

34. A storage medium having data stored therein for when executed:
receiving an encapsulated command, the encapsulated command encoded within data associated with a second other command, receiving a third command for retrieving of data from the device, extracting the encapsulated command, executing the extracted encapsulated command to generate first response data, and in response to the third command providing the first response data.

35. A storage medium according to claim 34 wherein the storage medium comprises a USB storage device.

36. A storage medium according to claim 35 wherein the USB storage device comprises a USB flash memory storage device.
